(19) United States
(12) Patent Application Publication
(10) Pub. No.: US 2021/0034945 A1
(43) Pub. Date: Feb. 4, 2021

(54) PERSONALIZED COMPLIMENTARY ITEM RECOMMENDATIONS USING SEQUENTIAL AND TRIPLET NEURAL ARCHITECTURE

(71) Applicant: Walmart Apollo, LLC, Bentonville, AR (US)

(72) Inventors: Mansi MANE, Sunnyvale, CA (US); Rahul IYER, Santa Clara, CA (US); Stephen Dean GUO, Saratoga, CA (US); Kannan ACHAN, Saratoga, CA (US)

(21) Appl. No.: 16/527,411

(22) Filed: Jul. 31, 2019

(51) Int. Cl. G06N 3/04; G06N 5/02

(52) U.S. Cl. CPC G06N 3/04; G06N 5/02

(57) ABSTRACT

A system and method of generating complimentary items from a catalog of items is disclosed. A plurality of item attributes for each of a plurality of items is received and a multimodal embedding representative of the plurality of attributes is generated for each of the plurality of items. The multimodal embedding is configured to predict at least a subset of the received plurality of item attributes for each of the plurality of items. A triplet network including a node representative of each of the plurality of items is generated. The triplet network is generated based on the multimodal embedding for each of the plurality of items. A plurality of complimentary items is generated from the plurality of items. The plurality of complimentary items are selected by the triplet network based on an anchor item selection received from a user.

### TECHNICAL FIELD

This application relates generally to system and methods for item recommendation in e-commerce platforms and, more particularly, to personalized item recommendations using a multimodal embedding.

### BACKGROUND

User's interact with e-commerce interfaces, such as e-commerce websites, to select and purchase items from the inventory of the e-commerce interface. A user may add one or more items to a virtual cart that are related, for example, each being an object to be placed in a specific room of a house (such as a bedroom, dining room, etc.). When users are adding objects to the virtual cart, they may forget or be unaware of other, complimentary products that are available, such as products for the same room as the one or more items.

Current systems provide user recommendations based on past data that identifies items that have been purchased with the one or more items in the virtual cart. These items are presented to the user for consideration. However, new products added to the e-commerce inventory do not have past sales data and therefore cannot be associated with items in a user's cart, even when those items may be related or relevant. Certain current systems also use attribute matching, such as recommending blue items when other blue items are added to a user's cart. However, coverage of item attributes is generally low and does not play a major role in the purchase of certain item categories, such as home decor. In addition, attributes may be non-uniform and/or incorrect in some instances.

### SUMMARY

In some embodiments, a system is disclosed. The system includes a computing device configured to receive a plurality of item attributes for each of a plurality of items and generate a multimodal embedding representative of the plurality of attributes for each of the plurality of items. The multimodal embedding is configured to predict at least a subset of the received plurality of item attributes for each of the plurality of items. The computing device is further configured to generate a triplet network including a node representative of each of the plurality of items. The triplet network is generated based on the multimodal embedding for each of the plurality of items. The computing device is further configured to generate a plurality of complimentary items from the plurality of items. The plurality of complimentary items are selected by the triplet network based on an anchor item selection received from a user.

In some embodiments, a non-transitory computer readable medium having instructions stored thereon is disclosed. The instructions, when executed by a processor cause a device to perform operations including receiving a plurality of item attributes for each of a plurality of items and generating a multimodal embedding representative of the plurality of attributes for each of the plurality of items. The multimodal embedding is configured to predict at least a subset of the received plurality of item attributes for each of the plurality of items. The instructions further configure the processor to generate a triplet network including a node representative of each of the plurality of items. The triplet network is generated based on the multimodal embedding for each of the plurality of items. The instructions further configure the processor to generate a plurality of complimentary items from the plurality of items. The plurality of complimentary items are selected by the triplet network based on an anchor item selection received from a user.

In some embodiments, a method is disclosed. The method includes steps of receiving a plurality of item attributes for each of a plurality of items and generating a multimodal embedding representative of the plurality of attributes for each of the plurality of items. The multimodal embedding is configured to predict at least a subset of the received plurality of item attributes for each of the plurality of items. A triplet network including a node representative of each of the plurality of items is generated. The triplet network is generated based on the multimodal embedding for each of the plurality of items. A plurality of complimentary items is generated from the plurality of items. The plurality of complimentary items are selected by the triplet network based on an anchor item selection received from a user.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 illustrates a block diagram of a computer system, in accordance with some embodiments.

FIG. 2 illustrates a network configured to provide item recommendations to a user through an e-commerce interface, in accordance with some embodiments.

FIG. 3 illustrates a method of generating item recommendations for a user, in accordance with some embodiments.

FIG. 4 illustrates a process flow of the method of generating item recommendations illustrated in FIG. 3, in accordance with some embodiments.

FIG. 5 illustrates a method of generating a multimodal embedding for an item in an e-commerce inventory, in accordance with some embodiments.

FIG. 6 illustrates a process flow of the method of generating a multimodal embedding illustrated in FIG. 6, in accordance with some embodiments.

FIG. 7 illustrates a process flow for generating a triplet network for item recommendation, in accordance with some embodiments.

FIG. 8 illustrates a triplet recommendation set prior to training by a triplet network and the same triplet recommendation set after training by a triplet network.

FIG. 9 illustrates a complimentary embedding space containing complimentary items, in accordance with some embodiments.

FIG. 10 illustrates a process flow for generating a user embedding and style prediction for a specific user, in accordance with some embodiments.

FIG. 11 illustrates a process flow for re-ranking triplet networks based on user preferences, in accordance with some embodiments.

### DETAILED DESCRIPTION

The description of the preferred embodiments is intended to be read in connection with the accompanying drawings, which are to be considered part of the entire written description of this invention. The drawing figures are not necessarily to scale and certain features of the invention may be shown exaggerated in scale or in somewhat schematic form in the interest of clarity and conciseness. In this description, relative terms such as “horizontal,” “vertical,” “up,” “down,” “top,” “bottom,” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “inwardly” versus “outwardly,” “longitudinal” versus “lateral” and the like are to be interpreted relative to one another or relative to an axis of elongation, or an axis or center of rotation, as appropriate. Terms concerning attachments, coupling and the like, such as “connected” and “interconnected,” refer to a relationship wherein structures are secured or attached to one another either directly or indirectly through intervening structures, as well as both moveable or rigid attachments or relationships, unless expressly described otherwise. The term “operatively coupled” is such an attachment, coupling, or connection that allows the pertinent structures to operate as intended by virtue of that relationship. In the claims, means-plus-function clauses, if used, are intended to cover structures described, suggested, or rendered obvious by the written description or drawings for performing the recited function, including not only structure equivalents but also equivalent structures.

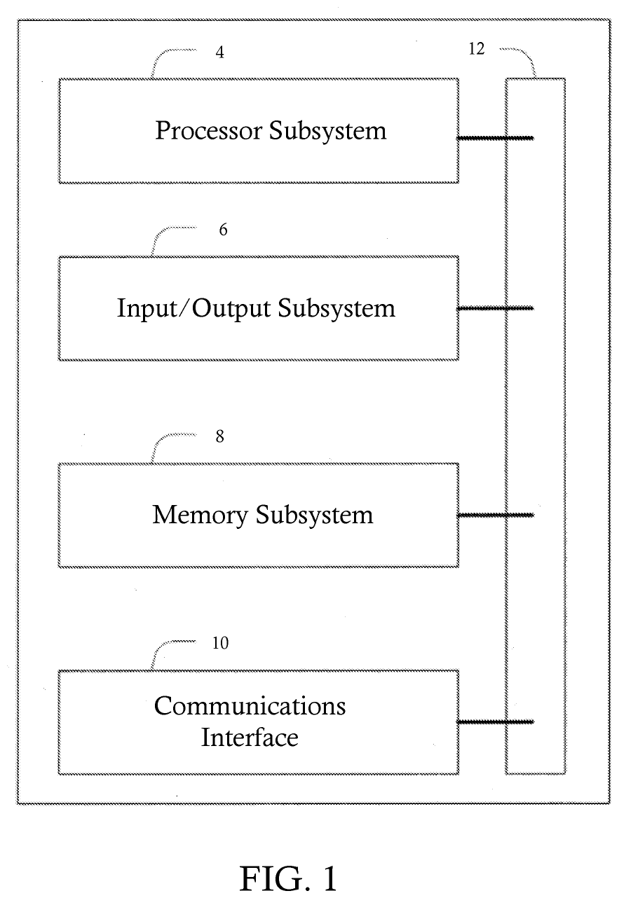

FIG. 1 illustrates a computer system configured to implement one or more processes, in accordance with some embodiments. The system 2 is a representative device and may comprise a processor subsystem 4, an input/output subsystem 6, a memory subsystem 8, a communications interface 10, and a system bus 12. In some embodiments, one or more than one of the system 2 components may be combined or omitted such as, for example, not including an input/output subsystem 6. In some embodiments, the system 2 may comprise other components not combined or comprised in those shown in FIG. 1. For example, the system 2 may also include, for example, a power subsystem. In other embodiments, the system 2 may include several instances of the components shown in FIG. 1. For example, the system 2 may include multiple memory subsystems 8. For the sake of conciseness and clarity, and not limitation, one of each of the components is shown in FIG. 1.

The processor subsystem 4 may include any processing circuitry operative to control the operations and performance of the system 2. In various aspects, the processor subsystem 4 may be implemented as a general purpose processor, a chip multiprocessor (CMP), a dedicated processor, an embedded processor, a digital signal processor (DSP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The processor subsystem 4 also may be implemented by a controller, a microcontroller, an application specific integrated circuit (ASIC), a field programmable gate array (FPGA), a programmable logic device (PLD), and so forth.

In various aspects, the processor subsystem 4 may be arranged to run an operating system (OS) and various applications. Examples of an OS comprise, for example, operating systems generally known under the trade name of Apple OS, Microsoft Windows OS, Android OS, Linux OS, and any other proprietary or open source OS. Examples of applications comprise, for example, network applications, local applications, data input/output applications, user interaction applications, etc.

In some embodiments, the system 2 may comprise a system bus 12 that couples various system components including the processing subsystem 4, the input/output subsystem 6, and the memory subsystem 8. The system bus 12 can be any of several types of bus structure(s) including a memory bus or memory controller, a peripheral bus or external bus, and/or a local bus using any variety of available bus architectures including, but not limited to, 9-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect Card International Association Bus (PCMCIA), Small Computers Interface (SCSI) or other proprietary bus, or any custom bus suitable for computing device applications.

In some embodiments, the input/output subsystem 6 may include any suitable mechanism or component to enable a user to provide input to system 2 and the system 2 to provide output to the user. For example, the input/output subsystem 6 may include any suitable input mechanism, including but not limited to, a button, keypad, keyboard, click wheel, touch screen, motion sensor, microphone, camera, etc.

In some embodiments, the input/output subsystem 6 may include a visual peripheral output device for providing a display visible to the user. For example, the visual peripheral output device may include a screen such as, for example, a Liquid Crystal Display (LCD) screen. As another example, the visual peripheral output device may include a movable display or projecting system for providing a display of content on a surface remote from the system 2. In some embodiments, the visual peripheral output device can include a coder/decoder, also known as Codecs, to convert digital media data into analog signals. For example, the visual peripheral output device may include video Codecs, audio Codecs, or any other suitable type of Codec.

The visual peripheral output device may include display drivers, circuitry for driving display drivers, or both. The visual peripheral output device may be operative to display content under the direction of the processor subsystem 6. For example, the visual peripheral output device may be able to play media playback information, application screens for application implemented on the system 2, information regarding ongoing communications operations, information regarding incoming communications requests, or device operation screens, to name only a few.

In some embodiments, the communications interface 10 may include any suitable hardware, software, or combination of hardware and software that is capable of coupling the system 2 to one or more networks and/or additional devices. The communications interface 10 may be arranged to operate with any suitable technique for controlling information signals using a desired set of communications protocols, services or operating procedures. The communications interface 10 may comprise the appropriate physical connectors to connect with a corresponding communications medium, whether wired or wireless.

Vehicles of communication comprise a network. In various aspects, the network may comprise local area networks (LAN) as well as wide area networks (WAN) including without limitation Internet, wired channels, wireless channels, communication devices including telephones, computers, wire, radio, optical or other electromagnetic channels, and combinations thereof, including other devices and/or components capable of/associated with communicating data. For example, the communication environments comprise in-body communications, various devices, and various modes of communications such as wireless communications, wired communications, and combinations of the same.

Wireless communication modes comprise any mode of communication between points (e.g., nodes) that utilize, at least in part, wireless technology including various protocols and combinations of protocols associated with wireless transmission, data, and devices. The points comprise, for example, wireless devices such as wireless headsets, audio and multimedia devices and equipment, such as audio players and multimedia players, telephones, including mobile telephones and cordless telephones, and computers and computer-related devices and components, such as printers, network-connected machinery, and/or any other suitable device or third-party device.

Wired communication modes comprise any mode of communication between points that utilize wired technology including various protocols and combinations of protocols associated with wired transmission, data, and devices. The points comprise, for example, devices such as audio and multimedia devices and equipment, such as audio players and multimedia players, telephones, including mobile telephones and cordless telephones, and computers and computer-related devices and components, such as printers, network-connected machinery, and/or any other suitable device or third-party device. In various implementations, the wired communication modules may communicate in accordance with a number of wired protocols. Examples of wired protocols may comprise Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, to name only a few examples.

Accordingly, in various aspects, the communications interface 10 may comprise one or more interfaces such as, for example, a wireless communications interface, a wired communications interface, a network interface, a transmit interface, a receive interface, a media interface, a system interface, a component interface, a switching interface, a chip interface, a controller, and so forth. When implemented by a wireless device or within wireless system, for example, the communications interface 10 may comprise a wireless interface comprising one or more antennas, transmitters, receivers, transceivers, amplifiers, filters, control logic, and so forth.

In various aspects, the communications interface 10 may provide data communications functionality in accordance with a number of protocols. Examples of protocols may comprise various wireless local area network (WLAN) protocols, including the Institute of Electrical and Electronics Engineers (IEEE) 802.xx series of protocols, such as IEEE 802.11a/b/g/n, IEEE 802.16, IEEE 802.20, and so forth. Other examples of wireless protocols may comprise various wireless wide area network (WWAN) protocols, such as GSM cellular radiotelephone system protocols with GPRS, CDMA cellular radiotelephone communication systems with 1xRTT, EDGE systems, EV-DO systems, EV-DV systems, HSDPA systems, and so forth. Further examples of wireless protocols may comprise wireless personal area network (PAN) protocols, such as an Infrared protocol, a protocol from the Bluetooth Special Interest Group (SIG) series of protocols (e.g., Bluetooth Specification versions 5.0, 6, 7, legacy Bluetooth protocols, etc.) as well as one or more Bluetooth Profiles, and so forth. Yet another example of wireless protocols may comprise near-field communication techniques and protocols, such as electro-magnetic induction (EMI) techniques. An example of EMI techniques may comprise passive or active radio-frequency identification (RFID) protocols and devices. Other suitable protocols may comprise Ultra Wide Band (UWB), Digital Office (DO), Digital Home, Trusted Platform Module (TPM), ZigBee, and so forth.

In some embodiments, at least one non-transitory computer-readable storage medium is provided having computer-executable instructions embodied thereon, wherein, when executed by at least one processor, the computer-executable instructions cause the at least one processor to perform embodiments of the methods described herein. This computer-readable storage medium can be embodied in memory subsystem 8.

In some embodiments, the memory subsystem 8 may comprise any machine-readable or computer-readable media capable of storing data, including both volatile/non-volatile memory and removable/non-removable memory. The memory subsystem 8 may comprise at least one non-volatile memory unit. The non-volatile memory unit is capable of storing one or more software programs. The software programs may contain, for example, applications, user data, device data, and/or configuration data, or combinations therefore, to name only a few. The software programs may contain instructions executable by the various components of the system 2.

In various aspects, the memory subsystem 8 may comprise any machine-readable or computer-readable media capable of storing data, including both volatile/non-volatile memory and removable/non-removable memory. For example, memory may comprise read-only memory (ROM), random-access memory (RAM), dynamic RAM (DRAM), Double-Data-Rate DRAM (DDR-RAM), synchronous DRAM (SDRAM), static RAM (SRAM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, disk memory (e.g., floppy disk, hard drive, optical disk, magnetic disk), or card (e.g., magnetic card, optical card), or any other type of media suitable for storing information.

In one embodiment, the memory subsystem 8 may contain an instruction set, in the form of a file for executing various methods, such as methods including A/B testing and cache optimization, as described herein. The instruction set may be stored in any acceptable form of machine readable instructions, including source code or various appropriate programming languages. Some examples of programming languages that may be used to store the instruction set comprise, but are not limited to: Java, C, C++, C#, Python, Objective-C, Visual Basic, or .NET programming. In some embodiments a compiler or interpreter is comprised to convert the instruction set into machine executable code for execution by the processing subsystem 4.

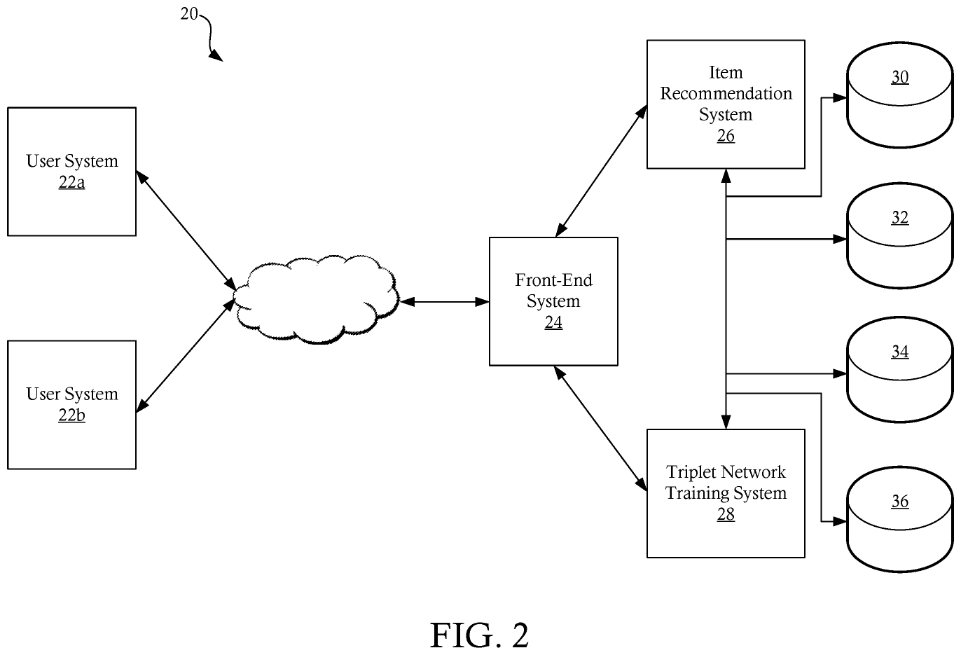

FIG. 2 illustrates a network 20 configured to provide an e-commerce interface, in accordance with some embodiments. The network 20 includes a plurality of user systems 22a, 22b configured to interact with a front-end system 24 that provides an e-commerce interface. The front-end system 24 may be any suitable system, such as, for example, a web server. The front-end system 24 is in communication with a plurality of back-end systems, such as, for example, an item recommendation system 26, a triplet network training system 28, and/or any other suitable system. The back-end systems may be in communication with one or databases, such as, for example, a product attribute database 30, a transactions database 32, a taxonomy database 34, user history database 36, and/or any other suitable database. It will be appreciated that any of the systems or databases illustrated in FIG. 2 may be combined into one or more systems and/or expanded into multiple systems.

In some embodiments, a user, using a user system 22a, 22b, interacts with the e-commerce interface provided by the front-end system 24 to select one or more items from an e-commerce inventory. After the user selects the one or more items, the front-end system 24 communicates with the item recommendation system 26 to generate one or more item recommendations based on the user selected items. As discussed in greater detail below, the item recommendation system 26 generates item recommendations using a multimodal embedding for each item in an e-commerce inventory, user item history, and/or a trained triple network.

In some embodiments, the item recommendation system 26 implements one or more processes (as discussed in greater detail below) to rank items and presents the first n ranked items to a user through the e-commerce interface provided by the front-end system 24. A user may select one or more of the recommended items (e.g., add the recommended items to their cart), which may result in new and/or additional items being recommended by the item recommendation system 26. In some embodiments, the recommended items are constrained by one or more rules, such as, for example, requiring recommended items to be diverse, to be for the same room (e.g., living room, kitchen, bedroom, etc.), and/or any other suitable rules.

In some embodiments, and as discussed in greater detail below, the item recommendations are modified based on prior user data, such as prior user purchase data, click data, etc. In some embodiments, item recommendations are generated by a triplet network for a “generic user.” The triplet network may be generated by the triple network training system 28. After generating the item recommendations, the item recommendation system 26 loads user preference data (e.g., click data, prior purchase data, etc.) from a database and re-ranks the item recommendations to correspond to user preferences. The re-ranked item recommendations are provided from the item recommendation system 26 to the front-end system 24 for presentation to the user, via the user system 22a, 22b.

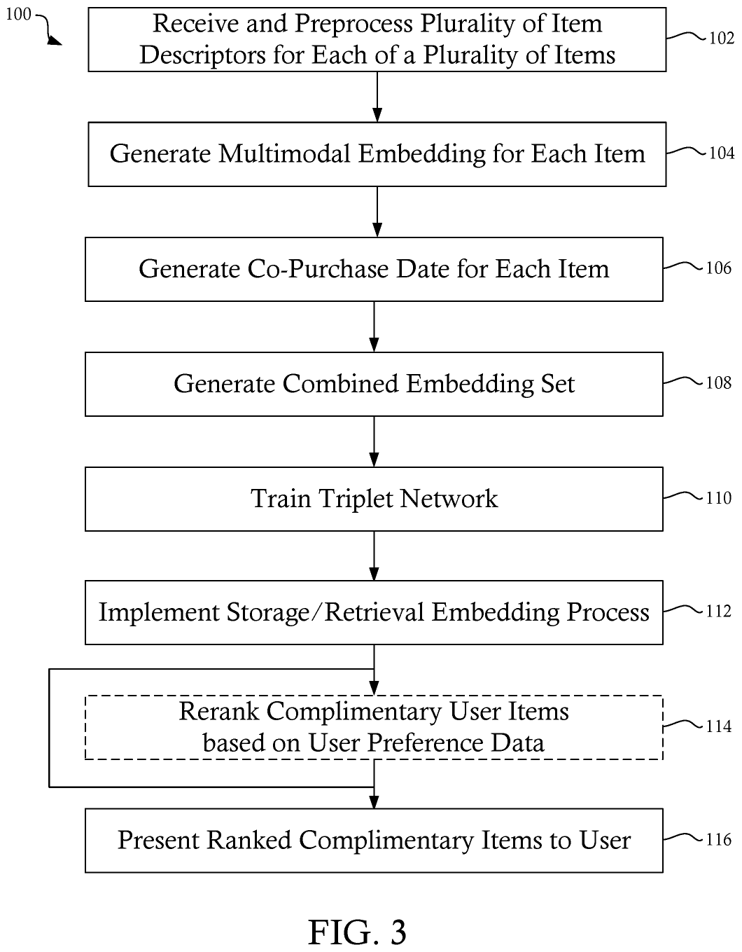

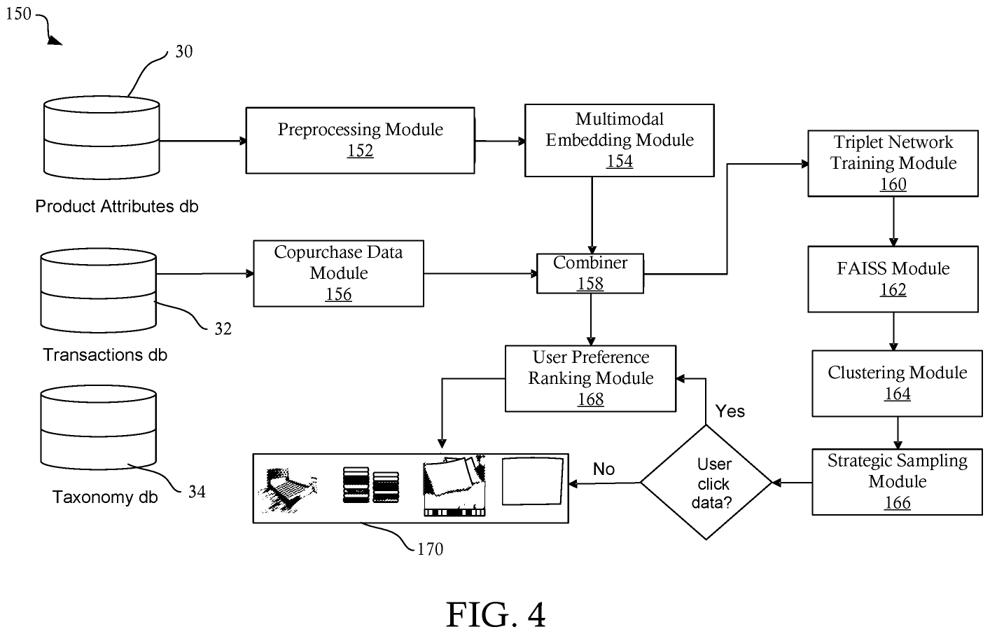

FIG. 3 illustrates a method 100 of generating item recommendations using multimodal embeddings, user preference data, and a trained triplet network, in accordance with some embodiments. FIG. 4 illustrates a process flow 150 of the method 100 illustrated in FIG. 3, in accordance with some embodiments. At step 102, one or more item descriptors are received and preprocessed by a system, such as the item recommendation system 26. The item descriptors may be received from, for example, a product attributes database 30. Product descriptors may include, but are not limited to, textual descriptors, visual descriptors, product attribute descriptors, etc. Preprocessing may include, for example, normalization, filtering, and/or any other suitable preprocessing. In some embodiments, the received descriptors are filtered to remove descriptors with low coverage (for example, retaining descriptors that are present only in a certain percentage of items in the inventory). Received descriptors, such as product attribute descriptors, may be filtered using frequency thresholding techniques, frequency distribution techniques, and/or any other suitable filtering techniques. A preprocessing module 152 may be configured to implement one or more filtering techniques. Although specific embodiments are discussed herein, it will be appreciated that the received descriptors can be normalized, filtered, and/or otherwise preprocessed according to any suitable rules or requirements.

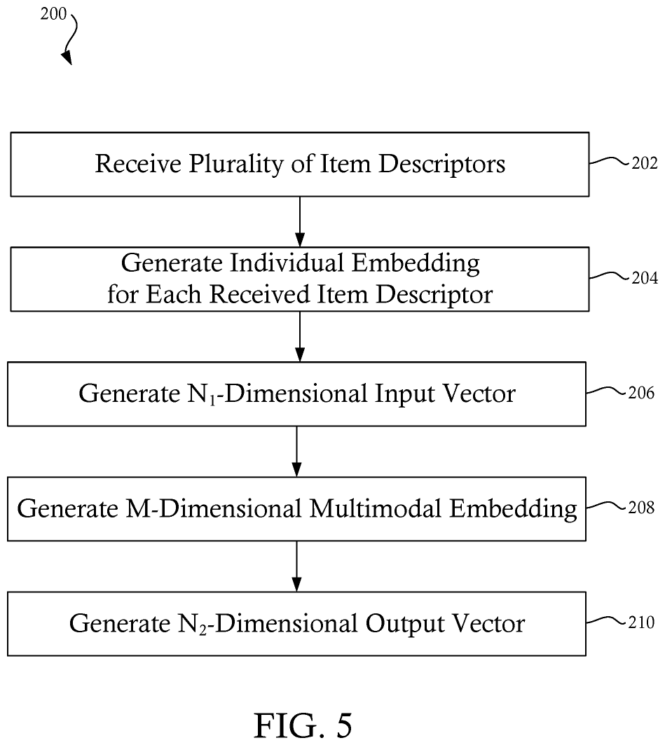

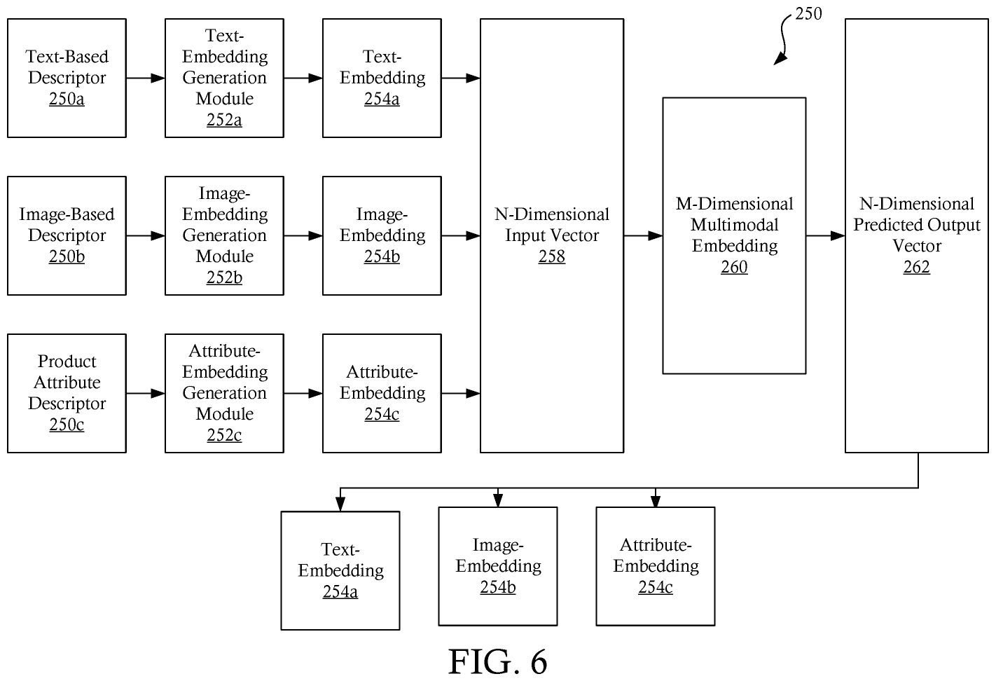

At step 104, a multimodal embedding is generated for each product in the e-commerce inventory by a multimodal embedding module 154. FIG. 5 illustrates a method 200 of generating a multimodal embedding for a product in an e-commerce inventory, in accordance with some embodiments. FIG. 6 illustrates process flow 250 of the method 200 illustrated in FIG. 5. At step 202, a system, such as the item recommendation system 26, receives a plurality of item descriptors 250a-250c. The plurality of item descriptors 250a-250c may include, but are not limited to, text-based descriptors 250a (such as text descriptions of products), visual descriptors 250b (such as images or videos illustrating a product), product attribute descriptors 250c (such as, but not limited to, brand, color, finish, material, style, category-specific style, product type, primary price, room location, category, subcategory, title, product description, etc.), and/or any other suitable item descriptors.

At step 204, an embedding is generated for each of the received descriptors 250a-250c. Embeddings include a real-value vector representation of the received descriptors. Each embedding may be generated by a suitable embedding generation module 252a-252c. For example, in the illustrated embodiment, a text-embedding generation module 252a is configured to receive the text descriptor 250a of the product and generate a text embedding 254a using a text encoding network, such as a universal sentence encoder (USE). Although specific embodiments are discussed herein, it will be appreciated that any suitable natural language processing and/or other sentence processing module may be applied to generate text embeddings for the received textual descriptors.

As another example, in the illustrated embodiment, image-embedding generation module 252b is configured to receive visual descriptors 250b (e.g., images of the current item) and generate an image embedding using 254b an image recognition network, such as, for example, a residual neural network (RESNET). Although specific embodiments are discussed herein, it will be appreciated that any suitable image recognition network and/or system may be applied to generate image embeddings for the received visual descriptors.

As yet another example, in the illustrated embodiment, attribute-embedding generation module 252c is configured to receive the product attribute descriptors 250c and generate an attribute embedding 254c for each received product attribute descriptor using, for example, an autoencoder network. An autoencoder includes a neural network configured for dimensionality reduction, e.g., feature selection and extraction.

At step 206, the generated item embeddings 254a-254c are combined into an N₁-dimensional input vector 258. The N₁-dimensional input vector 258 is provided to a multimodal embedding module 154. In some embodiments, the received item embeddings 254a-254c are concatenated to to generate the N₁-dimensional input vector 258.

At step 208, the multimodal embedding module 154 is configured to generate a M-dimensional multimodal embedding 260 from the N₁-dimensional input vector 258. As shown in FIG. 5, the multimodal embedding module 154 is configured to receive a N₁-dimensional input vector 258. The N₁-dimensional input vector 258 may include each of the individual embeddings 254a-254c combined to generate a single input vector, with each dimension of the N₁-dimensional input vector 258 corresponding to one of the individual embeddings 254a-254c. In other embodiments, the N₁-dimensional input vector 258 may include a subset of the received individual embeddings 254a-254c. The multimodal embedding module 154 is configured to reduce the N₁-dimensional input vector 258 to a M-dimensional multimodal embedding 260, where M is less than N₁ (e.g., the multimodal embedding 260 has fewer nodes than the N₁-dimensional input vector 258). For example, in various embodiments, the N₁-dimensional input vector 258 may include a 100-dimension input vector and the M-dimensional multimodal embedding 260 may include a 20-dimension vector, a 30-dimension vector, etc. Although specific embodiments are discussed herein, it will be appreciated that the N₁-dimensional input vector 258 can include any number of dimensions and the M-dimensional multimodal embedding 260 can include any number of dimensions that is less than the N₁-dimensional input vector 258.

In some embodiments, the multimodal embedding module 154 includes a denoising contractive autoencoder configured to combine each of the received individual embeddings into a single, multimodal embedding that can be decoded into the used individual embeddings. A denoising autoencoder is a stochastic version of a basic autoencoder. The denoising autoencoder address identify-function risk by introducing noise to randomly corrupt input. The denoising autoencoder then attempts to reconstruct the input after conversion to an embedding and the autoencoding is selected only if a successful reconstruction occurs. A contractive autoencoder is configured to provide a regularized, or penalty term, to the cost or objective function that is being minimized, e.g., the vector size of the multimodal embedding. The contractive autoencoder has a reduced sensitivity to variations in input. In other embodiments, any suitable bi-directional symmetrical neural network may be selected to generate a multimodal embedding from a plurality of individual embedding inputs.

In some embodiments, the multimodal embedding module 154 is configured to filter individual embeddings which have a low probability of prediction and/or low coverage. For example, in some embodiments, the multimodal embedding module 154 is configured to ignore (or filter) embeddings for individual attributes having less than a predetermined percentage of coverage for items in the catalog.

At step 210, the multimodal embedding module 154 generates an N₂-dimensional output vector 262. In some embodiments, the N₂-dimensional output vector 262 is generated by reversing a reduction or encoding process implemented by the multimodal embedding module 154 to generate the M-dimensional multimodal embedding 260. For example, in some embodiments, the multimodal embedding module 154 includes an autoencoder configured to convert from a reduced encoding (i.e., the M-dimensional multimodal embedding) to the N₂-dimensional output vector 262. At step 212, the N₂-dimensional output vector 262 is compared to the N₁-dimensional input vector 258. If the N₁-dimensional input vector 258 and the N₂-dimensional output vector 262 are substantially similar (e.g., N₁≈N₂, the majority of the vectors in the N₁-dimensional input vector 258 and the N₂-dimensional output vector 262 are identical, etc.), the method proceeds to step 214 and the M-dimensional multimodal embedding 260 is determined to be a final embedding. If the N₁-dimensional input vector 258 and the N₂-dimensional output vector 262 are not substantially similar, the method 200 returns to step 208 and generates a new M-dimensional multimodal embedding 260.

With reference again to FIGS. 3 and 4, at step 106, co-purchase data for each item in the e-commerce inventory is generated (e.g., extracted) for a predetermined time period. In some embodiments, the co-purchase data is generated by a co-purchase module 156 configured to extract co-purchase data from transaction data received from a transaction database 32, category data received from a taxonomy database 34, and/or any other suitable data. The predetermined time period may be any suitable time period, such as, for example, the prior 3-months, the prior 6-months, the prior year, etc. Co-purchase data indicates which items were purchased with the current item during the predetermined time period. Co-purchase data may include same-transaction purchases (as received from the transaction database 32), products purchased over multiple transactions in the same category (as received from the taxonomy database 34), and/or any other suitable co-purchase data.

At step 108, the multimodal embedding 260 for the current item (e.g., an anchor item) and a multimodal embedding for at least one co-purchased item are combined (e.g., joined) to generate a combined embedding set. Co-purchased items may include complimentary items to the current item (e.g., items purchased for the same room (e.g., sofa and end tables), in the same category (e.g., soap and towels), etc.) (referred to herein as positive items) and non-complimentary items (e.g., items purchased together but not for the same room (e.g., sofa and kitchen table), etc.) (referred to herein as negative items). The multimodal embeddings may be combined by a combiner 158. The combiner 158 may be configured to, for example, generate a triplet set of multimodal embeddings including an anchor item (e.g., item added by the user to the cart), a positive item, and a negative item. Although embodiments are discussed herein including a triplet set, it will be appreciated that the multimodal embeddings may be combined into any suitable nodal set (e.g., graph).

After generating the combined set (e.g., graph) of co-purchased items, it is possible that negative items will be closer to positive items such that negative items are ranked higher for item recommendations. This may occur, for example, if items that are not complimentary are nevertheless commonly purchased together (for example, a floor lamp may be frequently purchased with a plunger as both of these items may be necessary when moving into a new apartment or home, but a plunger and a floor lamp may not be considered complimentary items under certain rule sets). In order to provide accurate item recommendations, a trained triplet network is used to minimize the distance between anchor items and positive items and maximize the distance between anchor items and negative items.

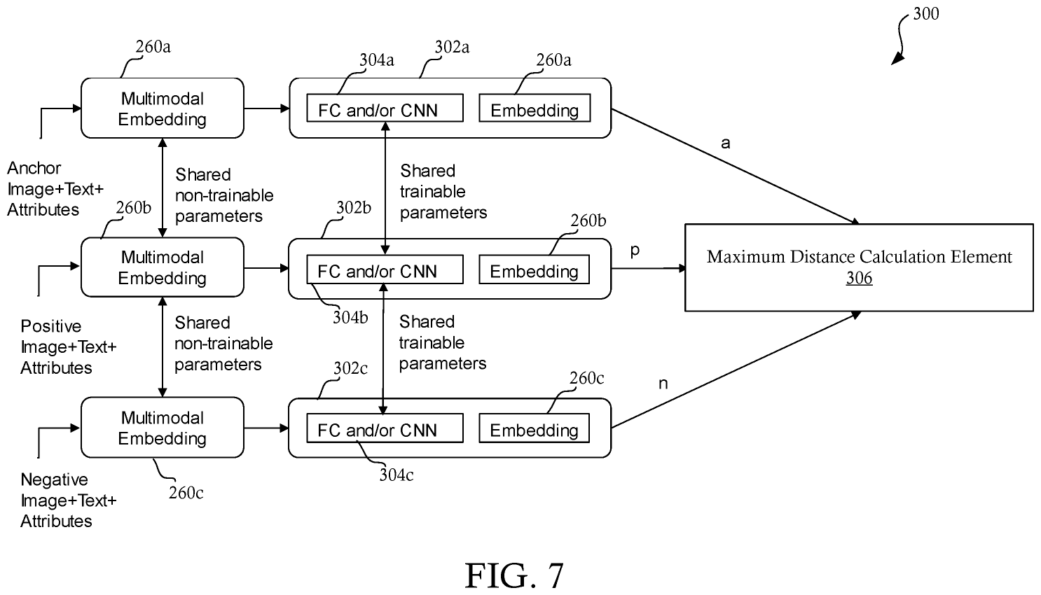

At step 110, the combined embedding sets, including both positive and negative items, provided to a triplet network training module 160 for training/refinement of the combined graph of embeddings. The triple network training module 160 implemented by any suitable system, such as, for example, the triple network training system 28 illustrated in FIG. 2. FIG. 7 illustrates a triplet network training process 300, in accordance with some embodiments. A system, such as the triplet network training system 28, is configured to receive a plurality of multimodal embeddings 260a-260c corresponding to one of an anchor item (anchor embedding 260a), a positive item (positive embedding 260b), or a negative item (negative embedding 260c). Each of the received embeddings 260a-260c are provided to a plurality of position determination network 302a-302c. Each position determination network 302a-302c includes a model 304a-304c configured to position an item (represented by a received embedding) within a triplet network (e.g., node network). The model 304a-304c may include any suitable neural network, such as, for example, a fully-connected (FC) neural network, a convolution neural network (CNN), a combined FC/CNN network, and/or any other suitable neural network. In some embodiments, the models 304a-304c include a single model shared among the plurality of position determination networks 302a-302c.

In the illustrated embodiment, a first position determination network 302a is configured to receive an anchor embedding 260a and determine a position, a, of the anchor item within the triplet network. Similarly, a second position determination network 302b is configured to receive a positive embedding 260b and determine a position, p, of the positive item within the triplet network and a third position determination network 302c is configured to receive a negative embedding 260c and determine a position, n, of the negative item within the triplet network.

The calculated positions are provided to a maximum distance calculation element 306 configured to determine whether the distance between the anchor item and the positive item is greater than the distance between the anchor item and the negative item. For example, in the illustrated embodiment, the maximum distance calculation element 306 determines a maximum of the difference in the distances between the anchor item and the positive item and negative item and zero, e.g.:

max(d(a, p)−d(a, n)+margin, 0)

where d(a,p) is the Euclidean distance between the anchor item and the positive item and d(a,n) is the Euclidean distance between the anchor item and the negative item (e.g., d(x,y) is the Euclidean distance between any two items, x and y). In some embodiments, if the anchor item and the negative item are separated by certain values, the triplet network will incur a large loss with respect to negative items and will be unable to focus on positive items. Separating the positive and negative items by a predetermined margin can avoid this loss. In the illustrated embodiment, a margin (e.g., a minimum separation value) is added to the distance equation. If the returned value is 0 (e.g., the distance equation is less than or equal to zero), the triplet network does not incur a loss for the negative item (e.g., the distance between the anchor item and the positive item is smaller than the distance between the anchor item and the negative item) and the triplet network prediction is considered correct. However, if the returned value is greater than 0, the distance between the positive item and the anchor item is greater than the distance between the anchor item and the negative item, requiring the models 304a-304c to be updated (e.g., retrained) to eliminate the calculated loss. Updated models may be shared between multiple position determination networks 302a-302c (e.g., are shared parameters of the networks 302a-302c).

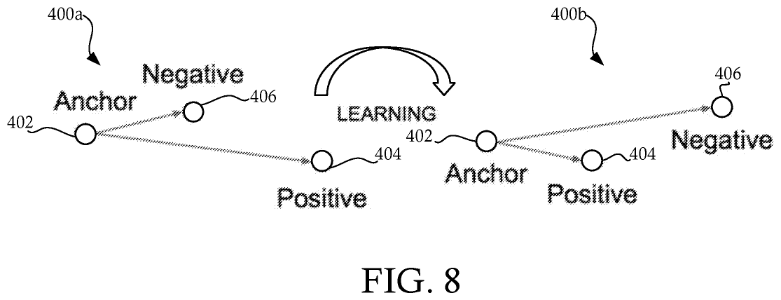

After training the triplet network at step 110, a triplet network includes shared parameters 302a-302c that are used to generate node representations for each item in the e-commerce catalog. FIG. 8 illustrates a first triplet set 400a prior to training at step 110 and a second triplet set 400b generated at step 110. As shown in FIG. 8, in the first triplet set 400a, a negative item 406 is positioned closer (e.g., has a smaller distance to) an anchor item 402 than a positive item 404. Because the negative item is closer, the first triplet network 400a incurs a large loss and will not provide correct item recommendations (e.g., will not recommend the positive item). However, after training by the triplet training network system 28, the second triplet set 400b has be rearranged to position the positive item 404 closer to the anchor item 402 than the negative item 406. Although a simple embodiment is illustrated, it will be appreciated that the triplet training network system 28 is configured to produce triplet networks containing a large number (e.g., thousands, millions, etc.) of nodes.

After generating a complimentary representation for each item (e.g., training the triplet network at step 110), the triplet network may be used to generate complimentary item recommendations. For example, in the simplest case, complimentary item recommendations may be generated by selecting the items having the smallest distance from a given anchor item within the triplet network. However, for large catalogs (e.g., thousands or millions of items), a distance calculation for each item is unrealistic (due to hardware and time constraints). At step 112, a system, such as the item recommendation system 26 and/or the triplet network training system 28, implement one or more processes to efficiently store and retrieve item embeddings within the triplet network, for example, a nearest-neighbor search (e.g., Facebook AI Similarity Search (FAISS) module 162), a clustering module 164, a strategic sampling module 166, and/or any other suitable process.

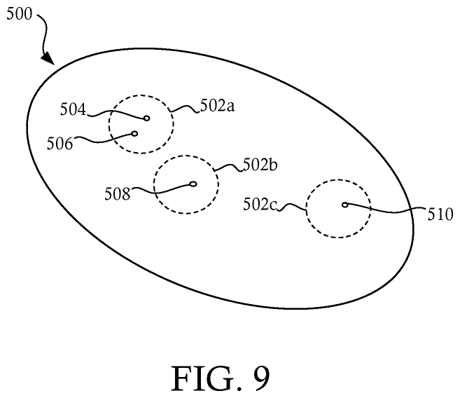

FIG. 9 illustrates a complementary embedding space 500, in accordance with some embodiments. The complementary embedding space 500 includes a plurality of embeddings, with each embedding represented by a node 504-510. The nodes 504-510 are positioned within the complementary embedding space 500 according to the trained triplet network generated at step 110. In some embodiments, the complementary embedding space 500 includes a plurality of clusters 502a-502c defining predetermined sets of items, such as, for example, a first cluster 502a containing beds, a second cluster 502b containing bedding, a third cluster 502c containing living room furniture, etc. Clusters 502a-502 may be exclusive and/or overlapping.

In some embodiments, the clusters 502a-502c are generated by a k-means clustering process (e.g., implemented by the clustering module 164 illustrated in FIG. 4). The k-means clustering process partitions the set of items within the complimentary embedding space 500 into k clusters 502a-502c in which each embedding belongs to a cluster with the nearest mean value. One or more heuristic algorithms may be implemented to generate local optimums (e.g., cluster centers) to define each of the k clusters 502a-502c.

In some embodiments, item recommendations are selected by performing sampling, such as strategic sampling, within one or more clusters 502a-502c, such as the n-closest clusters to the cluster associated with the anchor item (e.g., implemented by the strategic sampling module 166 illustrated in FIG. 4). For example, in the illustrated embodiment, an anchor item 504 (such as a metal bed) may be selected by a user and added to the user's cart. A strategic sampling mechanism determines the cluster associated with the anchor item 504, e.g., the first cluster 502a (e.g., a “bed” cluster). The strategic sampling mechanism calculates a distance between the center of the first cluster 502a and other clusters 502b, 502c in the complimentary embedding space 500. In the illustrated embodiment, the second cluster 502b (e.g., a “bedding” cluster) is closer to the first cluster 502a than the third cluster 502c (e.g., a “living room furniture” cluster).

After selecting the n-nearest clusters, a system, such as the item recommendation system 26, samples items within each selected cluster 502b and ranks the selected items based on available embeddings, such as trained multimodal embeddings. In some embodiments, the cluster 502a containing the anchor item 504 is excluded from the n-clusters sampled to generate complimentary items. For example, in the illustrated embodiment, the anchor item 504 is a metal bed and is contained with the first cluster 502a, e.g., a “bed” cluster. A second item 506, e.g., a wood bed, is contained with the first cluster 502a but is not selected as a complimentary item, as a user that has added a metal bed to their cart may not be interested in purchasing a second, wooden bed. In other embodiments, the cluster 502a associated with the anchor item 504 is included as one of the n-nearest clusters for sampling (e.g., items within the same cluster 502a may be selected as complimentary items).

With reference again to FIGS. 3 and 4, at step 114, the item recommendation system 26 (or any other suitable system) determines whether user data (e.g., prior purchase date, click data, etc.) exists for the current user and, if such data is available, reranks the identified complimentary items based on user preferences derived from the user data. In some embodiments, user data is maintained in a user history database 36, as illustrated in FIG. 2. User data may identify one or more user preferences, such as, for example, user style preferences, user color preferences, user brand preferences, etc. A representation of each user preference (e.g., a vector representation) is generated. Items sampled from each of the n-nearest clusters are compared to the user preferences and those items matching user preferences are ranked higher (even if positioned at a greater distance than other complimentary items). In some embodiments, the complimentary items are reranked by a user preference ranking module 168 configured to implement one or more processes for generating embeddings of user preferences and/or ranking complimentary items according to user preferences.

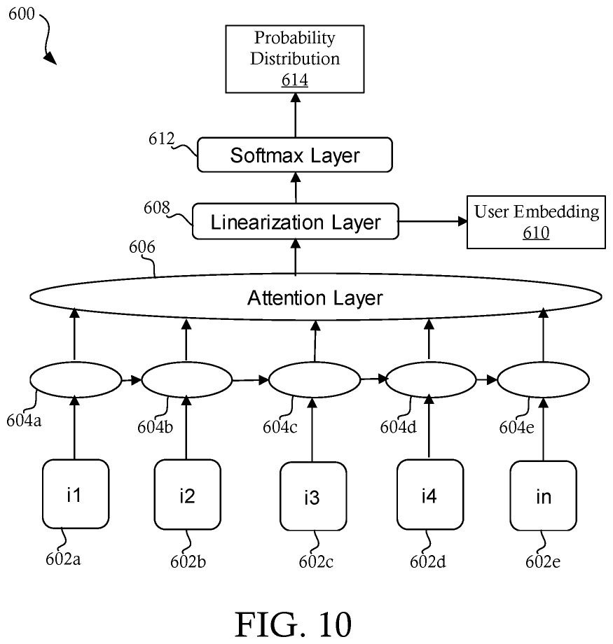

For example, FIG. 10 illustrates a process flow 600 for generating user representations (or embeddings) for user preferences. A system, such as the item recommendation system 26, receives user click data including a plurality of items i₁-iₙ 602a-602e. Each item i₁-iₙ 602a-602e is an item that a user has clicked on during an interaction with the e-commerce platform. User click data may be session specific and/or may be maintained over multiple interactions with the e-commerce system. An item embedding 604a-604e is generated (or retrieved) for each item 602a-602e in the user click data. A weighted average of the embeddings (e.g., an attention calculation) is generated by an attention layer 606. The weighted representation of the embeddings (e.g., weighted average) is linearized, for example, by a linearization layer 608. In various embodiments, the linearization layer 608 may include a weight matrix configured to convert the weighted representation into a lower dimensional space.

The output of the linearization layer 608 is a user preference embedding 610. In some embodiments, the user preference embedding 610 is provided to a softmax layer 612 that normalizes the user preference embedding into a probability distribution 614 consisting of K probabilities, where K is equal to the number of unique attributes (e.g., styles) in a dataset. After generating the probability distribution, a user attribute preference, such as, for example, a style preference vector 610, may be learnt by predicting a style of an item that a user adds to a cart, e.g., the highest probability in the probability distribution. In some embodiments, the process flow 600 illustrated in FIG. 10 allows user preference training and selection even when coverage of an attribute is low within an e-commerce catalog, as the probability distribution provides useful data all available product attributes of the products in the user click data.

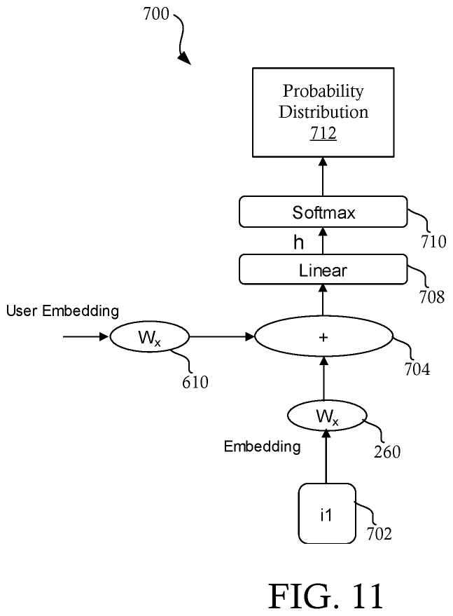

FIG. 11 illustrates a process flow 700 for re-ranking the output of a triplet network, for example as generated at step 110, based on user preferences. For each selected item 702, an item embedding 260 is received by a system, such as the item recommendation system 26. The item embedding 260 is compared with a user embedding 610 to determine whether the item 702 is complimentary with respect to the user. The user embedding 610 may be generated according to the process illustrated in FIG. 10 and discussed above. The item embedding 704 and the user embedding 610 are combined and/or otherwise compared, for example, by a concatenation module 704. The resulting combined embedding is provided to a linearization layer 708 that linearizes the received combined embedding, for example, by applying a weight matrix configured to convert the weighted representation into a lower dimensional space. The output of the linearization layer 708 is provided to a softmax layer 710 to generate a probability distribution 712 for the combined embedding. The probability distribution 712 is configured to predict whether the item 702 is a complimentary item with respect to the individual user.

With reference again to FIGS. 3 and 4, if user preference data is not available for the current user, the method 100 bypasses step 114 and proceeds directly to step 116. At step 116, the set 170 of complimentary items are presented to the user in ranked order. If user preference data was available at step 114, the set 170 includes complimentary items ranked according to the user preferences. If no user preference data was available, the set 170 includes complimentary items ranked according to the triplet network generated at steps 110 and 112. The method 100 is configured to provide recommendations to first-time users (through generic recommendations) and to address minimal coverage of certain attributes within a catalog (by using user click data for personalization).

As one example, in some embodiments, a training data set was provided in which the anchor item was shower curtains and liners and in which area rugs were often purchased together with the anchor item. Applying a simple universal sentence encoder to the item attributes produced a complimentary item ranking of: shower curtains and liners, kitchen towels, bed blankets, bed sheets, and area rugs. After applying the method 100 described herein, a new complimentary item ranking was generated, including: shower curtains and liners, bath rugs, area rugs, decorative pillows, bed blankets. As can be seen, the application of the method 100 increased the ranking of area rugs from fifth to third, increasing the frequency with which a user would see area rugs when selecting shower curtains and liners.

Although the subject matter has been described in terms of exemplary embodiments, it is not limited thereto. Rather, the appended claims should be construed broadly, to include other variants and embodiments, which may be made by those skilled in the art.

What is claimed is:

1. A system, comprising:
a computing device configured to:
receive a plurality of item attributes for each of a plurality of items;
generate a multimodal embedding representative of the plurality of attributes for each of the plurality of items, wherein the multimodal embedding is configured to predict at least a subset of the received plurality of item attributes for each of the plurality of items;
generate a triplet network including a node representative of each of the plurality of items, wherein the triplet network is generated based on the multimodal embedding for each of the plurality of items; and
generate a plurality of complimentary items from the plurality of items, wherein the plurality of complimentary items are selected by the triplet network based on an anchor item selection received from a user.

2. The system of claim 1, wherein generating the multimodal embedding for each of the plurality of items comprises:
generating an embedding for each of the plurality of attributes;
combining the embeddings for each of the plurality of attributes into an n-dimensional embedding; and
converting the n-dimensional embedding to an m-dimensional embedding, wherein m is less than.

3. The system of claim 2, wherein a contractive autoencoder is configured to convert the n-dimensional embedding to the m-dimensional embedding.

4. The system of claim 1, wherein generating the triplet network comprises:
receiving the anchor item, a positive item, and a negative item;
generating a node representative of each of the anchor item, positive item, and the negative item; and
calculating a triplet loss of a triplet defined by the node representative of each of the anchor item, the positive item, and the negative item, wherein the triplet network is configured to maximize a distance between the anchor item and the negative item and minimize a distance between the anchor item and the positive item.

5. The system of claim 4, wherein the triplet loss is calculated as:
max(d(a, p)−d(a, n)+margin, 0)
where a is a node position of the anchor item, p is a node position of the positive item, n is a node position of the negative item, d(a,p) is a Euclidean distance between the anchor item and the positive item, and d(a,n) is a Euclidean distance between the anchor item and the negative item.

6. The system of claim 4, wherein the node representative of each of the anchor item, the positive item, and the negative item is generated by a fully-connected (FC) neural network, a convolution neural network (CNN), or a combined FC/CNN network.

7. The system of claim 1, wherein generating the plurality of complimentary items from the plurality of items comprises:
generating a complimentary embedding space;
generating a plurality of clusters within the complimentary embedding space, wherein each of the plurality of clusters includes a subset of the plurality of items;
calculating a distance between a first cluster in the plurality of clusters and one or more additional clusters in the plurality of clusters, wherein the first cluster is a cluster containing the anchor item; and
selecting the plurality of complimentary items from each of the one or more additional clusters.

8. The system of claim 7, wherein the plurality of clusters are generated by a k-means clustering process.

9. The system of claim 7, wherein generating the plurality of complimentary items further comprises:
receiving user click data;
generating a user preference embedding from the user click data; and
ranking each of the plurality of complimentary items based on the user preference embedding.

10. The system of claim 9, wherein the ranking is based on a probability distribution of each of the plurality of complimentary items with respect to the user preference embedding.

11. A non-transitory computer readable medium having instructions stored thereon, wherein the instructions, when executed by a processor cause a device to perform operations comprising:
receiving a plurality of item attributes for each of a plurality of items;
generating a multimodal embedding representative of the plurality of attributes for each of the plurality of items, wherein the multimodal embedding is configured to predict at least a subset of the received plurality of item attributes for each of the plurality of items;
generating a triplet network including a node representative of each of the plurality of items, wherein the triplet network is generated based on the multimodal embedding for each of the plurality of items; and
generating a plurality of complimentary items from the plurality of items, wherein the plurality of complimentary items are selected by the triplet network based on an anchor item selection received from a user.

12. The non-transitory computer readable medium of claim 11, wherein generating the multimodal embedding for each of the plurality of items comprises:
generating an embedding for each of the plurality of attributes;
combining the embeddings for each of the plurality of attributes into an n-dimensional embedding; and
converting the n-dimensional embedding to an m-dimensional embedding, wherein m is less than.

13. The non-transitory computer readable medium of claim 12, wherein a contractive autoencoder is configured to convert the n-dimensional embedding to the m-dimensional embedding.

14. The non-transitory computer readable medium of claim 11, wherein generating the triplet network comprises:
receiving the anchor item, a positive item, and a negative item;
generating a node representative of each of the anchor item, positive item, and the negative item; and
calculating a triplet loss of a triplet defined by the node representative of each of the anchor item, the positive item, and the negative item, wherein the triplet network is configured to maximize a distance between the anchor item and the negative item and minimize a distance between the anchor item and the positive item.

15. The non-transitory computer readable medium of claim 14, wherein the triplet loss is calculated as:
max(d(a, p)−d(a, n)+margin, 0)
where a is a node position of the anchor item, p is a node position of the positive item, n is a node position of the negative item, d(a,p) is a Euclidean distance between the anchor item and the positive item, and d(a,n) is a Euclidean distance between the anchor item and the negative item.

16. The non-transitory computer readable medium of claim 14, wherein the node representative of each of the anchor item, the positive item, and the negative item is generated by a fully-connected (FC) neural network, a convolution neural network (CNN), or a combined FC/CNN network.

17. The non-transitory computer readable medium of claim 11, wherein generating the plurality of complimentary items from the plurality of items comprises:
generating a complimentary embedding space;
generating a plurality of clusters within the complimentary embedding space, wherein each of the plurality of clusters includes a subset of the plurality of items;
calculating a distance between a first cluster in the plurality of clusters and one or more additional clusters in the plurality of clusters, wherein the first cluster is a cluster containing the anchor item; and
selecting the plurality of complimentary items from each of the one or more additional clusters.

18. The non-transitory computer readable medium of claim 17, wherein the plurality of clusters are generated by a k-means clustering process.

19. The non-transitory computer readable medium of claim 17, wherein generating the plurality of complimentary items further comprises:
receiving user click data;
generating a user preference embedding from the user click data; and
ranking each of the plurality of complimentary items based on the user preference embedding, wherein the ranking is based on a probability distribution of each of the plurality of complimentary items with respect to the user preference embedding.

20. A method, comprising:
receiving a plurality of item attributes for each of a plurality of items;
generating a multimodal embedding representative of the plurality of attributes for each of the plurality of items, wherein the multimodal embedding is configured to predict at least a subset of the received plurality of item attributes for each of the plurality of items;
generating a triplet network including a node representative of each of the plurality of items, wherein the triplet network is generated based on the multimodal embedding for each of the plurality of items; and
generating a plurality of complimentary items from the plurality of items, wherein the plurality of complimentary items are selected by the triplet network based on an anchor item selection received from a user.
